(19) United States
(12) Patent Application Publication
(10) Pub. No.: US 2025/0068540 A1
(43) Pub. Date: Feb. 27, 2025

(54) DETERMINING WHETHER CONFIGURATIONS ON DIFFERENT EDGE SITES ARE EQUIVALENT

(71) Applicant: International Business Machines Corporation, Armonk, NY (US)

(72) Inventor: Kaustabha Ray, Bangalore (IN)

(21) Appl. No.: 18/238,035

(22) Filed: Aug. 25, 2023

(51) Int. Cl. G06F 11/34; G06F 11/30

(52) U.S. Cl. CPC G06F 11/3476; G06F 11/3024; G06F 11/3452

(57) ABSTRACT

A computer-implemented method, according to one embodiment, includes obtaining log information, and in response to a determination that the log information includes first log information associated with a first configuration of a first edge site and second log information associated with a second configuration of a second edge site, performing a first predetermined equivalence test. The first predetermined equivalence test includes generating first configuration probability distributions based on metrics of the first log information, generating second configuration probability distributions based on metrics of the second log information, calculating a first mean of the first configuration probability distributions and a second mean of the second configuration probability distributions, and determining a difference of the means. In response to a determination that the determined difference of the means is greater than a predetermined value, the second configuration of the second edge site is caused to be used for a service request.

### BACKGROUND

The present invention relates to service placement configurations in multi-cloud edge environments, and more specifically, this invention relates to determining whether configurations on different edge sites are equivalent.

A plurality of edge sites may exist within a cloud based environment, e.g., a multi-cloud edge environment. Each of these edge sites may be accessible by a plurality of edge devices. These edge devices may include one or more servers that are configured to process service requests that originate from user edge devices, e.g., cellular phones, laptop computers, tablets, etc., via wireless signals. The service requests may include transmitting communications, e.g., downloading and/or uploading, information associated with user edge device application services, e.g., object recognition, hotel reservations, social networking, media streaming, etc.

Within environments that include multiple edge sites, user edge devices are typically able to access server(s) of at least one edge site while the user edge devices incur only relatively low latency. Service request placement with respect to the different edge sites in a multi-cloud edge environment is typically based on service migration policies of a scheduler that routes service requests from user edge devices to servers of the edge sites.

### SUMMARY

A computer-implemented method, according to one embodiment, includes obtaining log information, and in response to a determination that the log information includes first log information associated with a first configuration of a first edge site and second log information associated with a second configuration of a second edge site, performing a first predetermined equivalence test. The first predetermined equivalence test includes generating first configuration probability distributions based on metrics of the first log information, and generating second configuration probability distributions based on metrics of the second log information. The first predetermined equivalence test further includes calculating a first mean of the first configuration probability distributions and a second mean of the second configuration probability distributions, and determining a difference of the first mean and the second mean. In response to a determination that the determined difference of the first mean and the second mean is greater than a predetermined value, the second configuration of the second edge site is caused to be used for a service request.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic being is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of the flowchart of FIG. 2A, in accordance with one embodiment of the present invention.

FIG. 2C is a flowchart of sub-operations of an operation of the flowchart of FIG. 2A, in accordance with one embodiment of the present invention.

FIGS. 3A-3B depict a multi-cloud edge environment, in accordance with one embodiment.

FIG. 4 is a collection of log information, in accordance with one embodiment of the present invention.

FIG. 5 is a graph, in accordance with one embodiment of the present invention.

FIGS. 6A-6B depict bit vectors, in accordance with one embodiment.

FIG. 7 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for determining whether configurations on different edge sites are equivalent.

In one general embodiment, a computer-implemented method includes obtaining log information, and in response to a determination that the log information includes first log information associated with a first configuration of a first edge site and second log information associated with a second configuration of a second edge site, performing a first predetermined equivalence test. The first predetermined equivalence test includes generating first configuration probability distributions based on metrics of the first log information, and generating second configuration probability distributions based on metrics of the second log information. The first predetermined equivalence test further includes calculating a first mean of the first configuration probability distributions and a second mean of the second configuration probability distributions, and determining a difference of the first mean and the second mean. In response to a determination that the determined difference of the first mean and the second mean is greater than a predetermined value, the second configuration of the second edge site is caused to be used for a service request.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic being is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as equivalence determination code of block 150 for determining whether configurations on different edge sites are equivalent. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

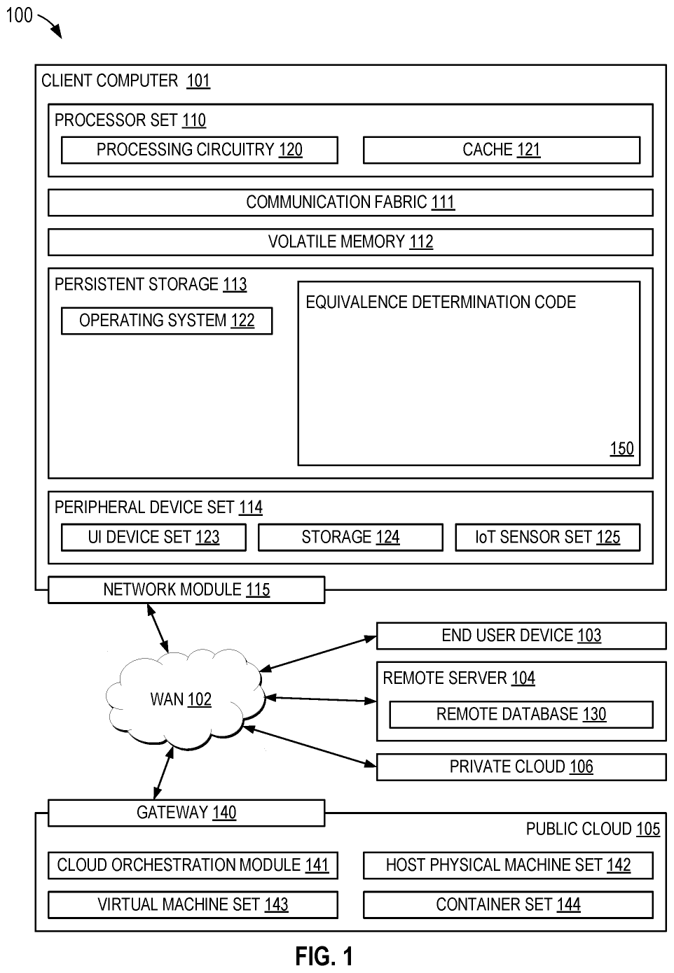

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere herein, a plurality of edge sites may exist within a cloud based environment, e.g., a multi-cloud edge environment. Each of these edge sites may be accessible by a plurality of edge devices. These edge devices may include one or more servers that are configured to process service requests that originate from user edge devices, e.g., cellular phones, laptop computers, tablets, etc., via wireless signals. The service requests may include transmitting communications, e.g., downloading and/or uploading, information associated with user edge device application services, e.g., object recognition, hotel reservations, social networking, media streaming, etc.

Within environments that include multiple edge sites, user edge devices are typically able to access server(s) of at least one edge site while the user edge devices incur only relatively low latency. Service request placement with respect to the different edge sites in a multi-cloud edge environment is typically based on service migration policies of a scheduler that routes service requests from user edge devices to servers of the edge sites. In some use cases, this routing of service requests may be performed across different edge sites, which, in turn, results in a relatively greater incurrence of latency during fulfillment of the service request because a relay is performed across a backbone link, e.g., a non-wireless link, that exists between the different edge sites. For example, a conventional scheduler may migrate a service request from a first server of a first edge site to a second server of a second edge site based on a service migration policy and in response to a determination that a service is no longer being used by user devices of the first edge site and is now being used by user devices of the second edge site, e.g., traffic volume associated with the use of the service has changed from the first edge site to the second edge site. Conventional schedulers do not consider metrics associated with different servers of different edge sites, and therefore some service requests are migrated to a second server of a second edge site from a first server of a first edge site despite the first and second edge servers being relatively equivalent servers. This results in an unnecessary incurring of latency as a result of performing migration and fulfillment operations over a backbone link between the first edge site and the second edge site.

In sharp contrast to the deficiencies of the conventional approaches described above, the embodiments and approaches described herein determine whether two placement configurations are equivalent and use the determination in order to relatively reduce an amount of latency that would otherwise be incurred as a result of performing service migrations across edge sites of a multi-cloud edge environment.

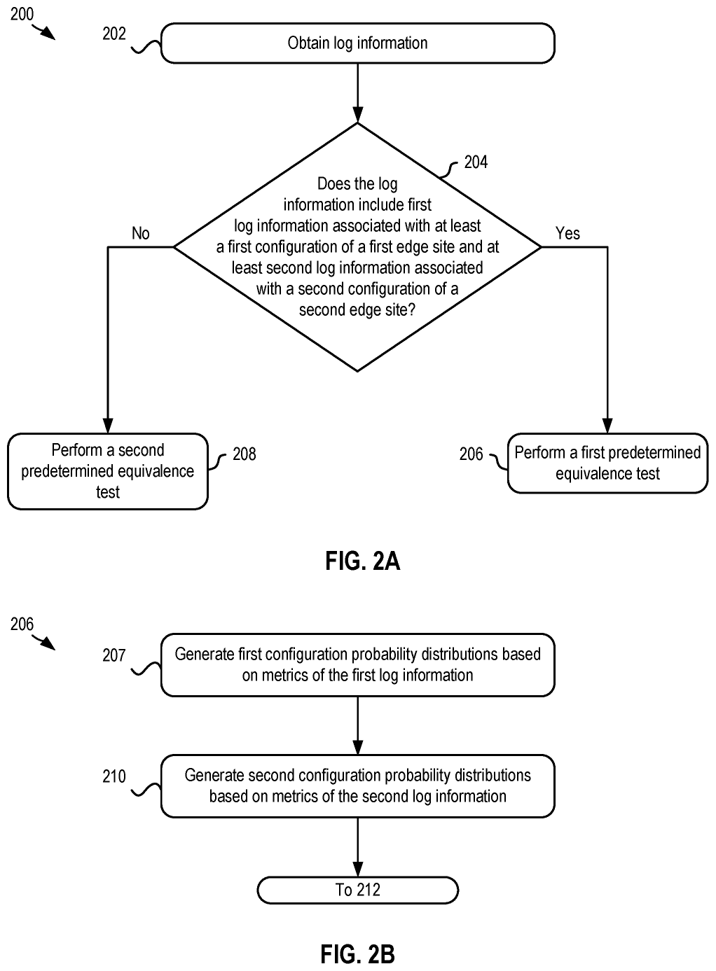

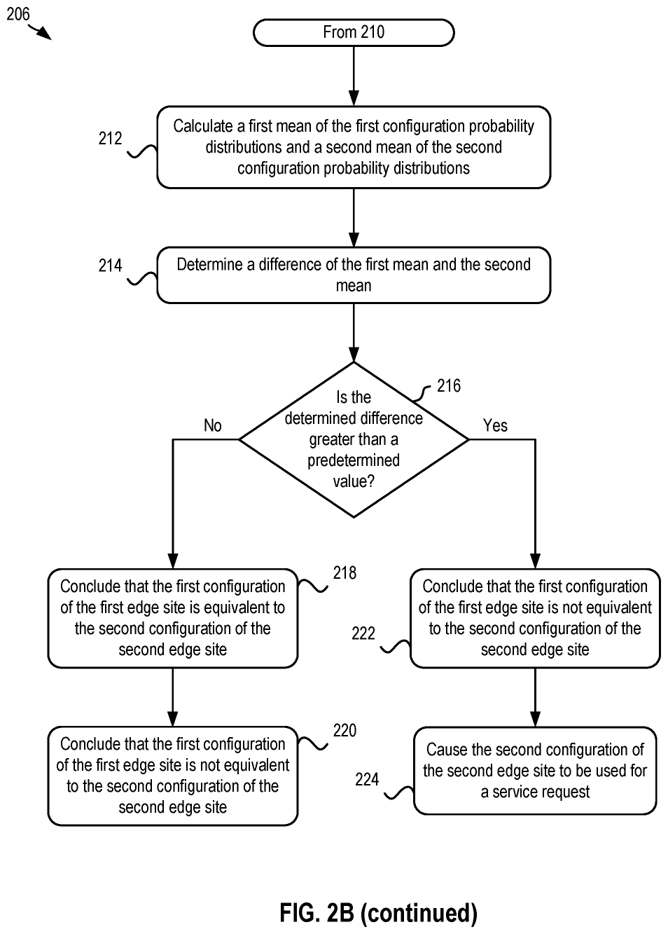

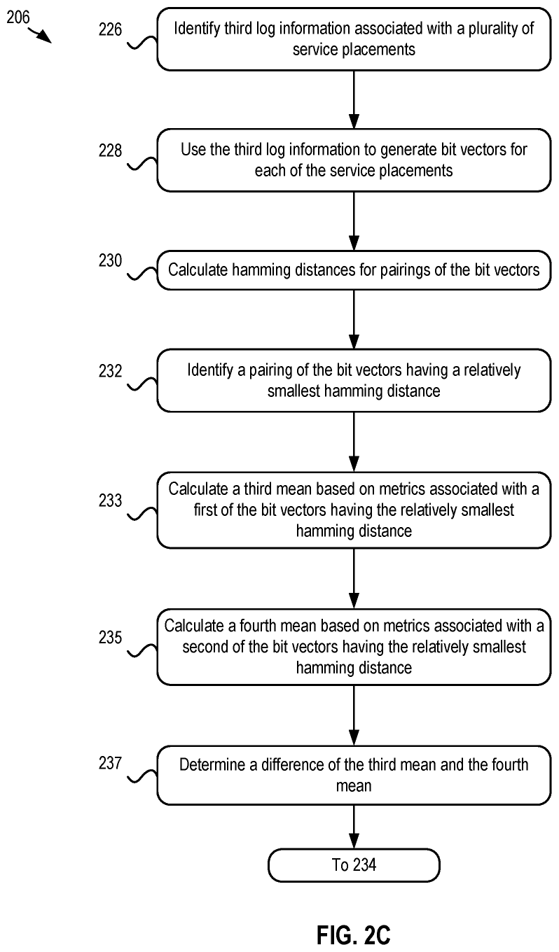

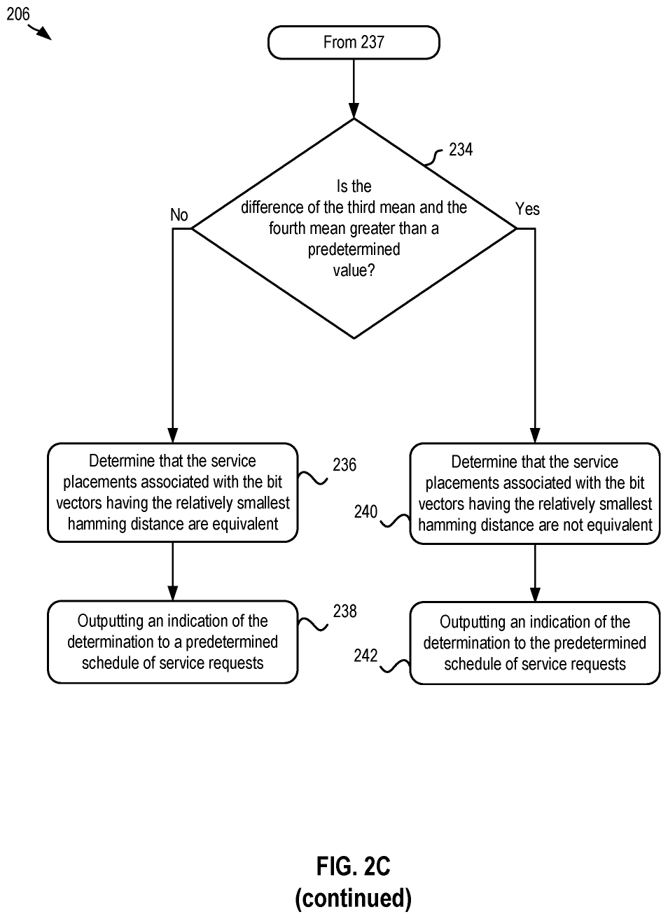

Now referring to FIG. 2A, a flowchart of a method 200 is shown according to one embodiment. The method 200 may be performed in accordance with the present invention in any of the environments depicted in FIGS. 1-7, among others, in various embodiments. Of course, more or fewer operations than those specifically described in FIG. 2A may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes obtaining log information. For context, the log information may, in some preferred approaches, be KCP log information. Moreover, the log information may include information that details performance of at least one, and preferably two or more edge sites. Each of the edge sites may include a plurality of edge devices, e.g., servers, user devices, etc., that are configured to communicate wirelessly within the edge site. A service request may, in some approaches, be routed from a user device to a server placement configuration, e.g., a server of a particular configuration of an edge site having a resource to fulfill the service request, within the same edge site. In some other approaches, such a service request may be routed from a user device of a first edge site to another server placement configuration in a second edge site using a backbone link between the first edge site and the second edge site.

The server placement configuration for a given service request may, in some preferred approaches, be determined based on log information. In preferred approaches herein, a service request is not migrated across edge sites to be fulfilled, e.g., from a first placement configuration to a second placement configuration, in the event that a determination is made that the two placement configurations are equivalent. For context, two placement configurations are defined as “equivalent”, where, for a given service request invocation distribution, a difference between an average predetermined metric, e.g., energy consumption, of servers is at most a predetermined value, e.g., epsilon. Accordingly, in some preferred approaches, method 200 includes determining whether log information is available for at least a first configuration of a first edge site and a second configuration of a second edge site, e.g., see decision 204. In some preferred approaches, the first configuration of a first edge site and a second configuration of a second edge site are configurations that are capable of fulfilling a pending service request, e.g., in the event that the pending service request is placed on the configuration(s).

The log information may be inspected to determine whether the log information is available for at least the first configuration of the first edge site and the second configuration of the second edge site using techniques that would become apparent to one of ordinary skill in the art after reading the descriptions herein. For example, in some approaches, natural language processing (NLP) techniques may be used for inspecting metadata of the log information to determine whether predetermined type of metrics are included for the first configuration of the first edge site and/or the second configuration of the second edge site in the obtained log information.

In response to a determination that the log information includes first log information associated with at least the first configuration of a first edge site and the second log information associated with a second configuration of a second edge site, e.g., as illustrated by the “Yes” logical path of decision 204, a first predetermined probability distribution equivalence test is performed, e.g., see operation 206. For context, the first predetermined probability distribution equivalence test is performed using the log information to determine whether use of the first configuration of the first edge site for a given service request is equivalent to use of the second configuration of the second edge site for the given service request. Looking to FIG. 2B, exemplary sub-operations of performing the first predetermined equivalence test are illustrated in accordance with one embodiment, one or more of which may be used to perform operation 206 of FIG. 2A. However, it should be noted that the sub-operations of FIG. 2B are illustrated in accordance with one embodiment which is in no way intended to limit the invention.

Sub-operation 207 of FIG. 2B includes generating first configuration probability distributions based on metrics of the first log information. For context, the metrics of the first log information may detail an averaged performance of servers at the first edge site. A second configuration probability distributions are preferably also generated based on metrics of the second log information, e.g., see sub-operation 210. For context, the metrics of the second log information may detail an averaged performance of servers at the second edge site. More specifically, in some preferred approaches, for each metric of the first log information under consideration, a probability distribution is fit for both the service placement configurations given a service request invocation distribution. For example, for sustainability, a power consumption metric, e.g., average power consumption, peak power consumption, etc., may be identified for the first configuration within the log information associated with the first configuration of the first edge site. The identified power consumption metric may be used to generate a first probability distribution of the first configuration probability distributions using techniques that would become apparent to one of ordinary skill in the art after reading the descriptions herein. Similarly, for sustainability, a power consumption metric may be identified for the second configuration within the log information included in the second configuration of the second edge site. The identified power consumption metric may be used to generate a first probability distribution of the second configuration probability distributions using techniques that would become apparent to one of ordinary skill in the art after reading the descriptions herein.

Although the above approach details that the configuration probability distributions may be based on a power consumption metric, in some approaches, the obtained log information preferably includes a plurality of different metrics. It should be noted that the metrics of the first log information and the metrics of the second log information are preferably the same type of metrics. This way, the first configuration probability distributions and the second configuration probability distributions may be generated using the same type of metrics, and thereby be compared with one another (as will be described elsewhere below). In one or more approaches, the metrics may additionally and/or alternatively include, e.g., central processing unit (CPU) utilization, load, throughput, response time, tail latency, etc. In some preferred approaches, the metrics may additionally and/or alternatively include a number of page faults.

Sub-operation 212 includes calculating a first mean, e.g., statistical mean, of the first configuration probability distributions and a second mean of the second configuration probability distributions. It should be noted that although some approaches described above specify that a statistical mean may be calculated for the first configuration probability distributions and a statistical mean may be calculated for the second configuration probability distributions, in some other approaches, another predetermined type of statistical value may be calculated. For example, in some of such approaches, a statistical median may be calculated for the first configuration probability distributions and a statistical median may be calculated for the second configuration probability distributions. In some other approaches, a statistical mode may be calculated for the first configuration probability distributions and a statistical mode may be calculated for the second configuration probability distributions. Known techniques for calculating the predetermined type of statistical value based on the probability distributions that would become apparent to one of ordinary skill in the art after reading the descriptions herein may be used.

Sub-operation 214 includes determining a difference of the first mean and the second mean, e.g., the difference in means. It may be noted that the difference of the first mean and the second mean being a relatively smaller value (or even zero) infers that the first configuration is relatively equivalent, while the difference of the first mean and the second mean being a relatively larger value infers that the first configuration is relatively non-equivalent. The difference of the first mean and the second mean may be determined by comparing the determined difference with a predetermined value. For example, sub-operation 216 includes determining whether the determined difference is greater than a predetermined value. In one preferred approach, the predetermined value is epsilon. In some other approaches, the predetermined value is, e.g., a fraction that is less than the value of one, five, ten, one hundred, etc., and may be dynamically adjusted. For example, in some approaches, the predetermined value may be decreased in response to a determination that communication traffic on the backbone link between the first cluster site and the second cluster site is less than a predetermined threshold, e.g., not relatively busy. In contrast, in one or more of such approaches, the predetermined value may be increased in response to a determination that communication traffic on the backbone link between the first cluster site and the second cluster site is greater than a predetermined threshold, e.g., relatively busy. This adjustment of the predetermined threshold increases performance in the multi-cloud edge environment by at least temporarily dynamically scaling down migrations performed across cluster sites in response to a determination that the backbone link between the cluster sites is relatively busy.

It should be noted that, although the current approach assumes that each of the means are based on a respective set of configuration probability distributions, in some other approaches, the means and determined differences may be based on a single type of metric.

In response to a determination that the determined difference is greater than a predetermined value, e.g., as illustrated by the “Yes” logical path of sub-operation 216, that the first configuration of the first edge site is concluded to be not equivalent to the second configuration of the second edge site, e.g., see sub-operation 222. In some approaches, in response to such a conclusion, the second configuration of the second edge site may be caused, e.g., see sub-operation 224, to be used for a service request, e.g., instead of using the first configuration of the first edge site for a service request. Causing the second configuration of the second edge site to be used for the service request, in some approaches, optionally includes instructing a predetermined schedule to schedule the service request to be fulfilled by a server included in the second configuration. In one or more of such approaches, the predetermined schedule is a scheduler of the edge sites and that is configured and/or used to make service placements within the edge sites.

Referring again to sub-operation 216 of FIG. 2B, in response to a determination that the determined difference is less than or equal to the predetermined value, e.g., as illustrated by the “No” logical path of sub-operation 216, a conclusion may be made that the first configuration of the first edge site is equivalent to the second configuration of the second edge site, e.g., see sub-operation 218. In some approaches, in response to such a conclusion, the first configuration of the first edge site may be caused to be used for the service request, e.g., see sub-operation 220. Causing the first configuration of the first edge site to be used for the service request, in some approaches, optionally includes instructing the predetermined schedule to schedule the service request to be fulfilled by a server associated with the first configuration, e.g., a server that offers a resource that can be used to fulfill the service request.

Referring again to FIG. 2A, in response to a determination that the log information does not include first log information associated with at least the first configuration of a first edge site and/or the second log information associated with a second configuration of a second edge site, e.g., as illustrated by the “No” logical path of decision 204, the first predetermined probability distribution equivalence test is not able to be performed, and therefore, in response to the determination, a second predetermined probability distribution equivalence test is performed instead, e.g., see operation 208. For context, the second predetermined probability distribution equivalence test is performed to determine whether use of the first configuration of the first edge site for a given service request is equivalent to use of the second configuration of the second edge site for the given service request.

Looking to FIG. 2C, exemplary sub-operations of performing the second predetermined equivalence test are illustrated in accordance with one embodiment, one or more of which may be used to perform operation 208 of FIG. 2A. However, it should be noted that the sub-operations of FIG. 2C are illustrated in accordance with one embodiment which is in no way intended to limit the invention.

Sub-operation 226 of FIG. 2C includes identifying third log information associated with a plurality of service placements. For context, service placements may be defined as the deployment of services in a server of an edge site for fulfilling the service request. The third log information preferably is based on an approximate matching service placement(s), e.g., other servers of the first edge node, other servers of a third edge node, other servers of a fourth edge node, etc., with logs that are available for obtaining the log information from. For context, the other service placement(s) may be determined to “approximately match” other service placements, e.g., a service placement that includes assignment of a service request to the first configuration of the first edge site, a service placement that includes assignment of the service request to the second configuration of the second edge site, etc., based on a determination that hardware that is assigned the service request being comparable for the two service placements. For example, a service placement on a third server of a third edge node may be determined to be an approximate match with service placement on the first server of a first edge node in response to a determination that the first server and the third server each include, e.g., a majority of the same hardware components, a majority of the same software components, within a predetermined amount of available processing resources, etc.

The third log information may, in some approaches, be identified within the obtained log information. In contrast, in some other approaches, in response to a determination that the obtained log information does not include third log information, an additional query for log information may be performed using log information querying techniques that would become apparent to one of ordinary skill in the art after reading the descriptions herein.

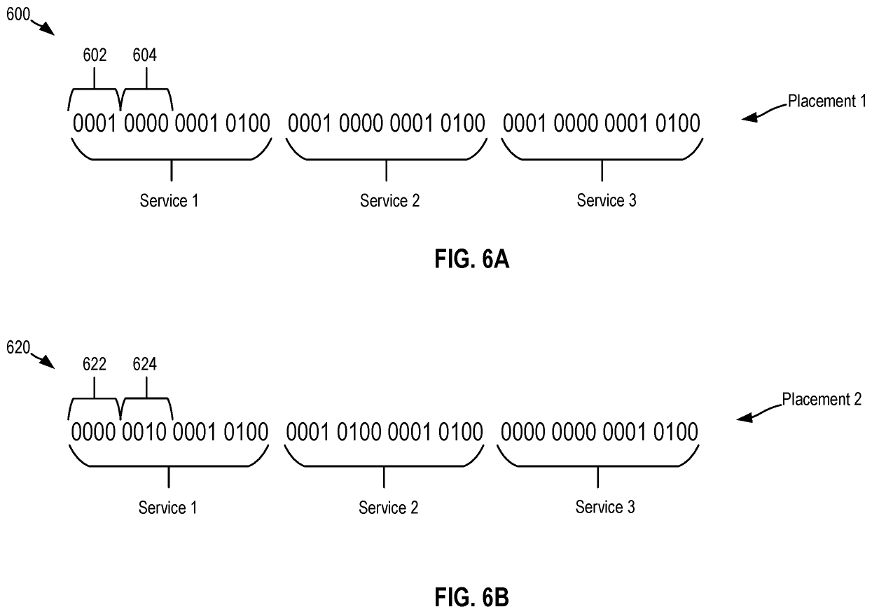

The third log information is used to generate bit vectors for each of the service placements, e.g., see sub-operation 228. A given one of the bit vectors, and preferably all of the bit vectors, include groups of bits that represent different associated services of the service placements. For example, these different associated services of the service placements may include user edge device application services, e.g., object recognition, hotel reservations, social networking, media streaming, etc. Each of these groups of bits may, in some approaches, include sub-groups of bits that correspond to the one or more edge sites. For example, in some preferred approaches, each sub-group of bits represent an edge site, and the bits of each sub-group of bits represent servers of the edge site. Furthermore, in some approaches, values of the bits of each sub-group of bits may indicate whether the associated service is deployed on servers of the edge site. For example, a first of the bits having a value of “1” may be used to indicate that a first service is deployed on a first server of the first edge site, while a second bit that is proximate to the first bit, i.e., within the same bit sub-group as the first bit, having a value of “0” may be used to indicate that the first service is not deployed on a second server of the first edge site. It may be noted that a further detailed example of such bit vectors is described elsewhere herein, e.g., see FIGS. 6A-6B.

Sub-operation 230 includes calculating bit vector hamming distances for pairings of the bit vectors. For example, a bit vector hamming distance may be calculated for a pairing that includes a first generated bit vector and a second generated bit vector, the first generated bit vector and a third generated bit vector, a first generated bit vector and a fourth generated bit vector, etc. Note that other combinations of bit vector comparisons may be used in other approaches. By comparing the first generated bit vector in pairings with the other generated bit vectors, a determination may be made with respect to which of the pairings include a relatively smallest hamming distance. For example, sub-operation 232 includes identifying a pairing of the bit vectors having a relatively smallest hamming distance. Such a determination may be performed by performing known techniques for performing value comparisons.

In some approaches, a mean of the metrics of the pairing with the relatively smallest hamming distance is computed, and a check is performed to determine whether the difference is greater than a predetermined value. In some approaches, this includes computing a mean for a first of the bit vectors of the pairing of bit vectors with the relatively smallest hamming distance, e.g., a third mean calculated in sub-operation 233, and computing a mean for a second of the bit vectors of the pairing of bit vectors with the relatively smallest hamming distance, e.g., a fourth mean calculated in sub-operation 235. These means may be calculated based on the third log information using techniques similar to those described elsewhere herein for calculating the first mean and second mean. Sub-operation 234 includes determining whether a difference of these means, e.g., a difference of the means of the metrics of the pairing with the smallest hamming distance difference determined in sub-operation 237, is greater than a predetermined value. In some approaches, the predetermined value that the difference of the means associated with the relatively smallest hamming distance placement configuration is compared with may be the same predetermined value described elsewhere above, e.g., epsilon, a fraction that is less than the value of one, five, ten, one hundred, etc. In response to a determination that the difference of the means is greater than the predetermined value, e.g., as illustrated by the “Yes” logical path of sub-operation 234, a determination is made that the service placements associated with the bit vectors having the relatively smallest hamming distance are not equivalent, e.g., see sub-operation 240. Furthermore, an indication of the determination that the service placements associated with the bit vectors having the relatively smallest hamming distance are not equivalent is output to the predetermined schedule of service requests to thereby cause, e.g., with provided instructions for allowing, service request migrations between the service placements associated with the bit vectors having the relatively smallest hamming distance, e.g., see sub-operation 242. Such migrations are acceptable based on the service placements not being equivalent, as the migrations otherwise occurring between equivalent service placements would result in unnecessarily incurred latency.

With reference again to sub-operation 234, in response to a determination that the difference of the means of the placement configurations with the relatively smallest hamming distance is less than or equal to the predetermined value, e.g., as illustrated by the “No” logical path of sub-operation 234, a determination is made that the service placements associated with the bit vectors having the relatively smallest hamming distance are equivalent, e.g., see sub-operation 236. Furthermore, an indication that the service placements associated with the bit vectors having the relatively smallest hamming distance are equivalent is output to the predetermined schedule, e.g., see sub-operation 238. This indication may cause, e.g., with provided instructions to not allow, service request migrations between the service placements associated with the bit vectors having the relatively smallest hamming distance to be prevented. Such migrations may be considered not acceptable based on the service placements being equivalent, as otherwise allowing performance of the service request migrations between the equivalent service placements would result in unnecessarily incurred latency.

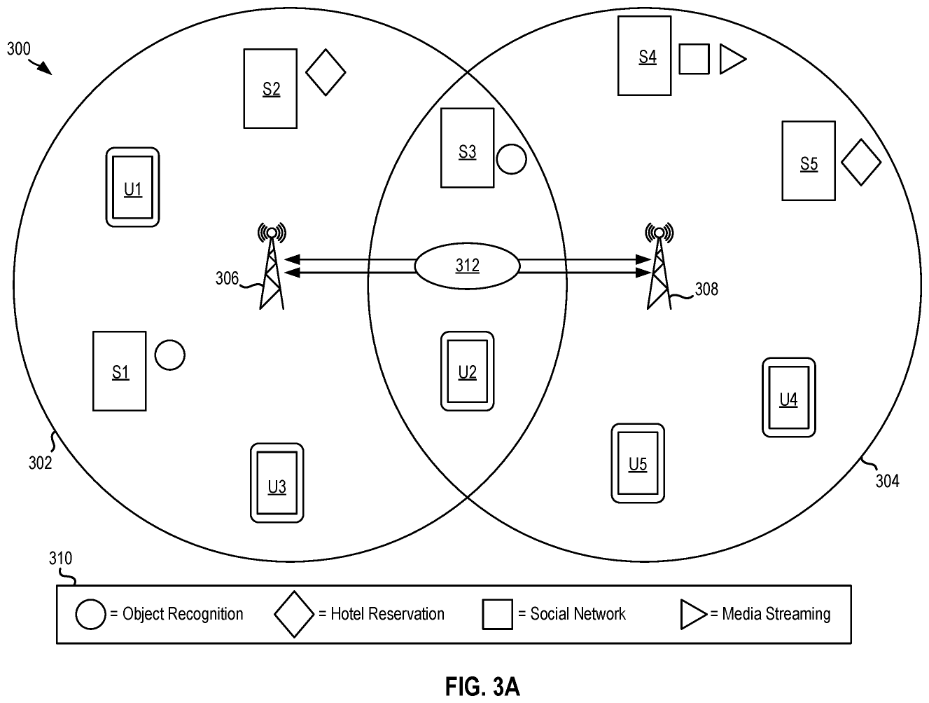

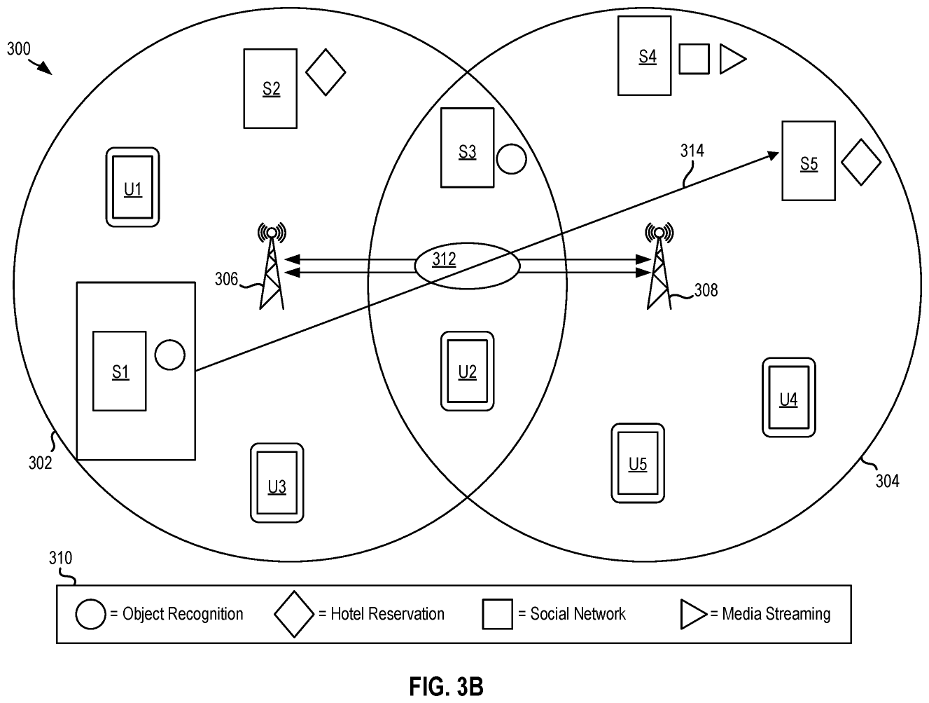

FIGS. 3A-3B depict a multi-cloud edge environment 300, in accordance with one embodiment. As an option, the present multi-cloud edge environment 300 may be implemented in conjunction with features from any other embodiment listed herein, such as those described with reference to the other FIGS. Of course, however, such multi-cloud edge environment 300 and others presented herein may be used in various applications and/or in permutations which may or may not be specifically described in the illustrative embodiments listed herein. Further, the multi-cloud edge environment 300 presented herein may be used in any desired environment.

The multi-cloud edge environment 300 includes multiple cloud edge sites, e.g., see first edge site 302 and second edge site 304. Each of the edge sites include user devices, e.g., user edge devices. For example, the first edge site 302 includes a first user device U1, a second user device U2, and a third user device U3. Similarly, the second edge site includes the second user device U2, the fourth user device U4 and the fifth user device U5. The user devices are able to access server(s) of at least one edge site while the user devices incur only relatively low latency, e.g., via wireless connections established by wireless cloud network signal infrastructure, e.g., see wireless cloud network signal infrastructure 306 and 308.

Service request placement with respect to the different edge sites in the multi-cloud edge environment may be performed by a scheduler, which may be a computer device that is configured to perform the operations described herein, e.g., see method 200, to determine where to route service requests of the user device. For context, this routing of service requests to a determined server is performed in order for the service request to be fulfilled using resources that are available to the servers and called for in the service request. For example, the resource table 310 includes indications of such resources, and the resource table 310 is shown distributed next to some of the servers of the edge sites.

In some use cases, this routing of service requests may be performed across different edge sites, e.g., using a backbone link 312. Referring now to FIG. 3B, this routing results in a relatively unnecessary incurrence of latency in the event that a service request is routed from a second server of the second edge site from the first edge site where a first server of the first edge site is relatively equivalent to the second server, e.g., see routing operation 314. In order to mitigate this relatively unnecessary incurrence of latency and reduce a number of service migrations that are performed across different edge sites, techniques described herein, e.g., see method 200, are preferably performed to determine whether such servers are equivalent.

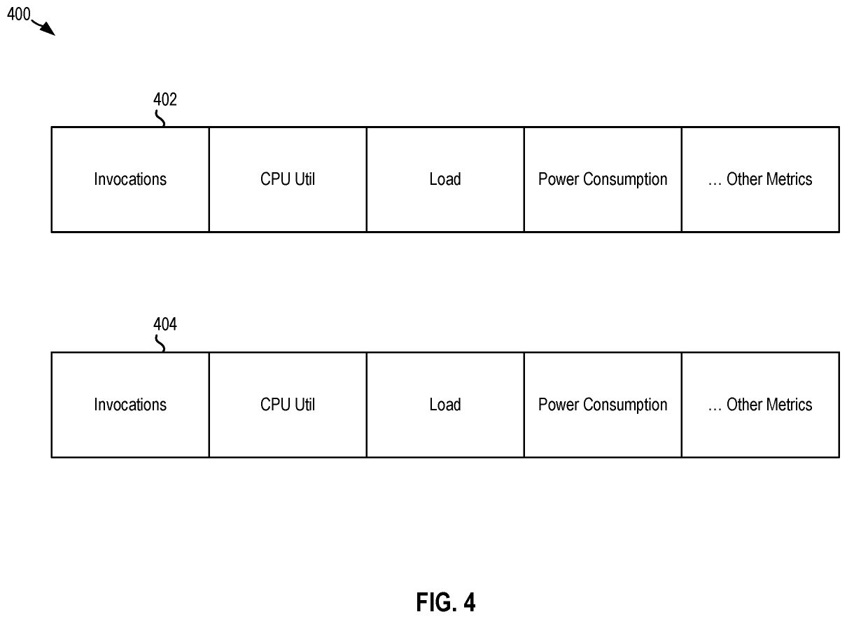

FIG. 4 depicts a collection 400 of log information for configurations of different edge sites, in accordance with one embodiment. As an option, the present collection 400 may be implemented in conjunction with features from any other embodiment listed herein, such as those described with reference to the other FIGS. Of course, however, such collection 400 and others presented herein may be used in various applications and/or in permutations which may or may not be specifically described in the illustrative embodiments listed herein. Further, the collection 400 presented herein may be used in any desired environment.

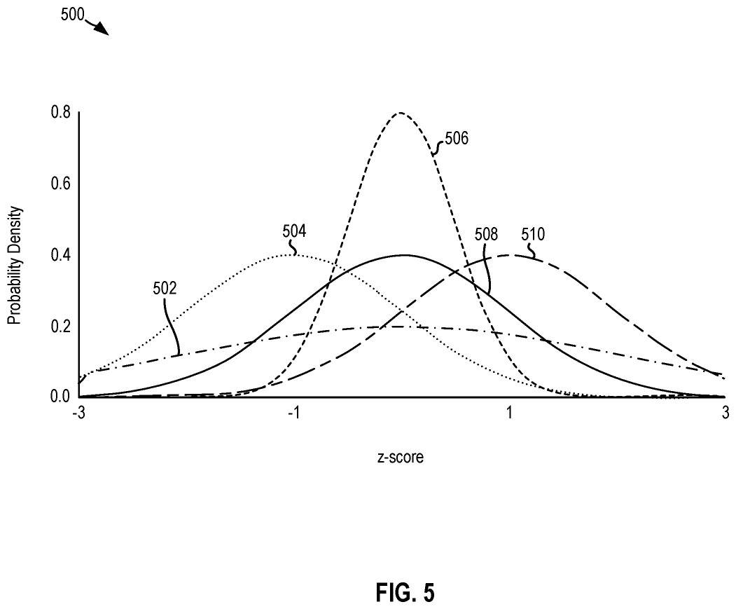

The collection 400 includes a first table 402 of log information for a first configuration of a first edge site and a second table 404 of log information for a second configuration of a second edge site. Tabular metrics are included in each of the tables. For example, a first of the metrics includes input distribution metrics, e.g., invocation distributions which is a probability distribution, that result in a plurality of output metrics from service placement configurations. For example, these output metrics include, e.g., CPU utilization, load, power consumption, and other metrics (such as those described elsewhere herein). It may be noted that the input distributions for the service placement configurations are preferably the same. Log information for the output metrics may be used to generate configuration probability distributions, e.g., see FIG. 5.

FIG. 5 depicts a configuration probability distribution graph 500, in accordance with one embodiment. As an option, the present configuration probability distribution graph 500 may be implemented in conjunction with features from any other embodiment listed herein, such as those described with reference to the other FIGS. Of course, however, such configuration probability distribution graph 500 and others presented herein may be used in various applications and/or in permutations which may or may not be specifically described in the illustrative embodiments listed herein. Further, the configuration probability distribution graph 500 presented herein may be used in any desired environment.

Configuration probability distribution graph 500 includes a plurality of configuration probability distributions, that are normal distributions plotted with respect to z-score and probability density, e.g., see x-axis and y-axis (respectively). More specifically, given a service request invocation distribution, the configuration probability distributions of the graph 500 are generated based on metrics obtained from log data of a first service placement configuration. For example, a first configuration probability distribution 502 is based on a first of the metrics, a second configuration probability distribution 504 is based on a second of the metrics, a third configuration probability distribution 506 is based on a third of the metrics, a fourth configuration probability distribution 508 is based on a fourth of the metrics, and a fifth configuration probability distribution 510 is based on a fifth of the metrics.

A mean of the configuration probability distributions may be calculated using the techniques described herein to determine whether the configuration associated with the configuration probability distributions is equivalent to another configuration. It should be noted that the plurality configuration probability distributions of configuration probability distribution graph 500 may be generated in response to a determination that obtained log information includes the log information associated with the configuration associated with the configuration probability distributions. In contrast, in response to a determination that the obtained log information does not include log information for two or more configurations that can be used to generate the configuration probability distributions of FIG. 5, a predetermined process may be performed that includes generating bit vectors in order determine whether placements in two or more different configuration are equivalent, e.g., see FIGS. 6A-6B.

FIGS. 6A-6B depict bit vectors 600 and 620, in accordance with one embodiment. As an option, the present bit vectors 600 and 620 may be implemented in conjunction with features from any other embodiment listed herein, such as those described with reference to the other FIGS. Of course, however, such bit vectors 600 and 620 and others presented herein may be used in various applications and/or in permutations which may or may not be specifically described in the illustrative embodiments listed herein. Further, the bit vectors 600 and 620 presented herein may be used in any desired environment.

Referring first to FIG. 6A, the bit vector 600 is generated for a first placement, e.g., see Placement 1. Similarly, in FIG. 6B, the bit vector 620 is generated for a second placement, e.g., see Placement 2. Each of the bit vectors include groups of bits that represent different associated services of the service placements, e.g., see Service 1, Service 2 and Service 3. Each group of bits includes sub-groups of bits that correspond to one or more edge sites, e.g., see example sub-group 602, sub-group 604, sub-group 622 and sub-group 624. Each sub-group of bits represent an edge site, and the bits of each sub-group of bits represent servers of the edge site, e.g., see “0” bits and “1” bits across the bit vectors. Values of the bits of each sub-group of bits indicate whether the associated service is deployed on servers of the edge site. A hamming distance may be calculated for the bit vectors and other bot vectors, and the determined hamming distance(s) may be used to determine whether the placements associated with the bit vectors are equivalent.

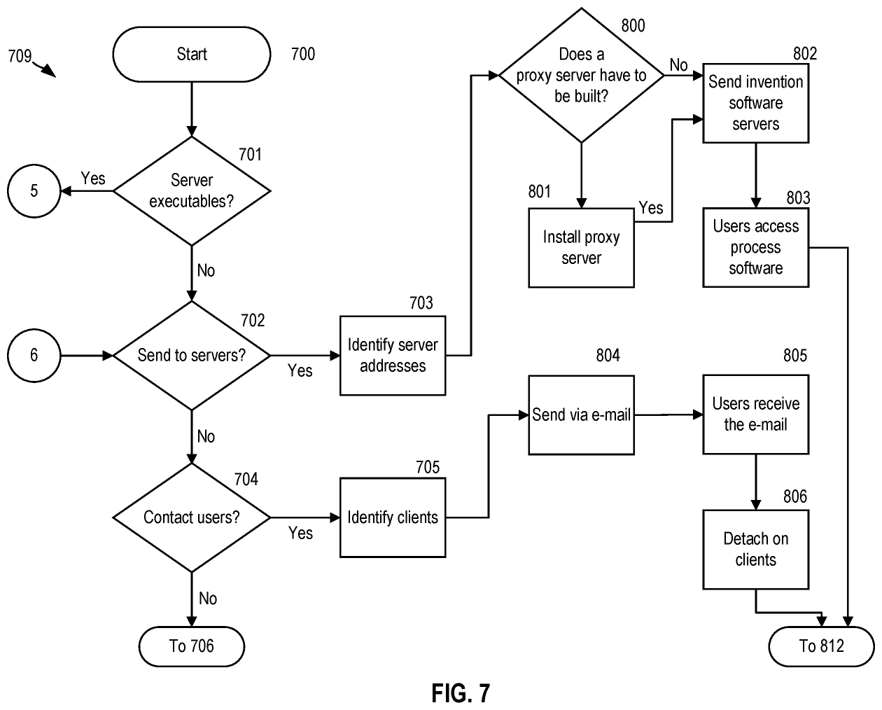

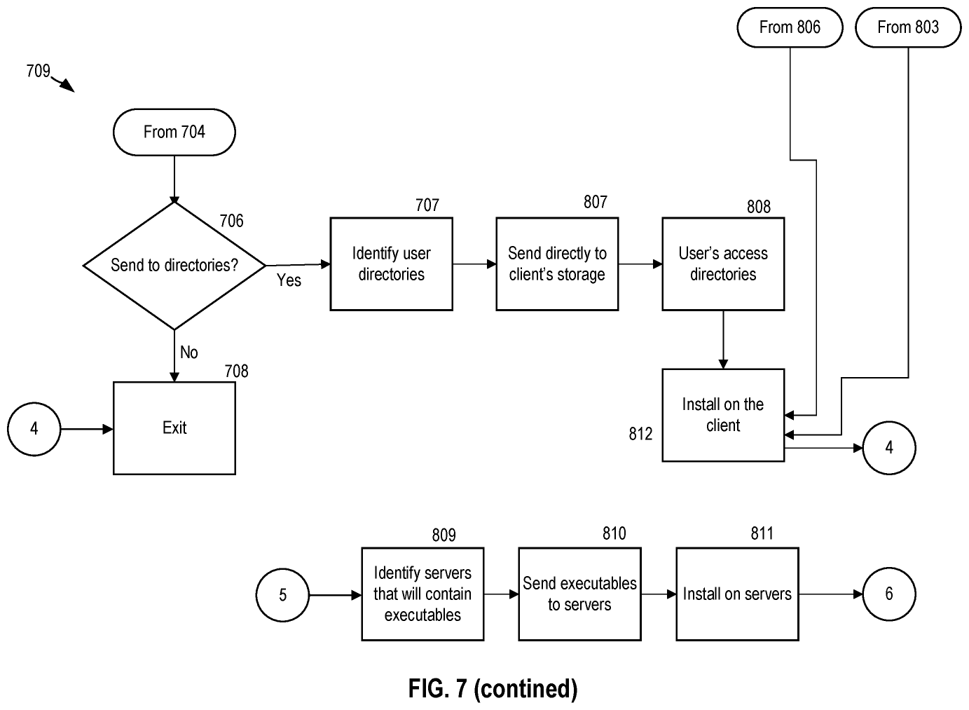

Now referring to FIG. 7, a flowchart of a method 709 is shown according to one embodiment. The method 709 may be performed in accordance with the present invention in any of the environments depicted in FIGS. 1-7, among others, in various embodiments. Of course, more or fewer operations than those specifically described in FIG. 7 may be included in method 709, as would be understood by one of skill in the art upon reading the present descriptions.

Each of the steps of the method 709 may be performed by any suitable component of the operating environment. For example, in various embodiments, the method 709 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 709. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software for performing a predetermined equivalence test for determining whether configurations on different edge sites are equivalent may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 700 begins the deployment of the process software. An initial step is to determine if there are any programs that will reside on a server or servers when the process software is executed (701). If this is the case, then the servers that will contain the executables are identified (809). The process software for the server or servers is transferred directly to the servers' storage via FTP or some other protocol or by copying though the use of a shared file system (810). The process software is then installed on the servers (811).

Next, a determination is made on whether the process software is to be deployed by having users access the process software on a server or servers (702). If the users are to access the process software on servers, then the server addresses that will store the process software are identified (703).

A determination is made if a proxy server is to be built (800) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (801). The process software is sent to the (one or more) servers either via a protocol such as FTP, or it is copied directly from the source files to the server files via file sharing (802). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (803). Another embodiment is to have the servers automatically copy the process software to each client and then run the installation program for the process software at each client computer. The user executes the program that installs the process software on his client computer (812) and then exits the process (708).

In step 704 a determination is made whether the process software is to be deployed by sending the process software to users via e-mail. The set of users where the process software will be deployed are identified together with the addresses of the user client computers (705). The process software is sent via e-mail (804) to each of the users' client computers. The users then receive the e-mail (805) and then detach the process software from the e-mail to a directory on their client computers (806). The user executes the program that installs the process software on his client computer (812) and then exits the process (708).

Lastly, a determination is made on whether the process software will be sent directly to user directories on their client computers (706). If so, the user directories are identified (707). The process software is transferred directly to the user's client computer directory (807). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (808). The user executes the program that installs the process software on his client computer (812) and then exits the process (708).

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining log information;
in response to a determination that the log information includes first log information associated with a first configuration of a first edge site and second log information associated with a second configuration of a second edge site, performing a first predetermined equivalence test, wherein the first predetermined equivalence test includes:
generating first configuration probability distributions based on metrics of the first log information;
generating second configuration probability distributions based on metrics of the second log information;
calculating a first mean of the first configuration probability distributions and a second mean of the second configuration probability distributions;
determining a difference of the first mean and the second mean; and
in response to a determination that the determined difference of the first mean and the second mean is greater than a predetermined value, causing the second configuration of the second edge site to be used for a service request.

2. The computer-implemented method of claim 1, comprising: in response to a determination that the determined difference is less than the predetermined value, causing the first configuration of the first edge site to be used for the service request.

3. The computer-implemented method of claim 1, wherein causing the second configuration of the second edge site to be used for the service request includes instructing a predetermined schedule to schedule the service request to be fulfilled by a server included in the second configuration, wherein causing the first configuration of the first edge site to be used for the service request includes instructing the schedule to schedule the service request to be fulfilled by a server associated with the first configuration.

4. The computer-implemented method of claim 1, comprising:
in response to a determination that the log information does not include the first log information and/or the second log information, performing a second predetermined equivalence test, wherein the second predetermined equivalence test includes:
identifying third log information associated with a plurality of service placements;
using the third log information to generate bit vectors for each of the service placements;
calculating hamming distances for pairings of the bit vectors;
identifying a pairing of the bit vectors having a relatively smallest hamming distance;
calculating a third mean based on metrics associated with a first of the bit vectors having the relatively smallest hamming distance;
calculating a fourth mean based on metrics associated with a second of the bit vectors having the relatively smallest hamming distance;
determining whether a difference of the third mean and the fourth mean is greater than the predetermined value; and
in response to a determination that the determined difference of the third mean and the fourth mean is greater than the predetermined value, determining that the service placements associated with the bit vectors having the relatively smallest hamming distance are not equivalent.

5. The computer-implemented method of claim 4, comprising: outputting an indication that the service placements associated with the bit vectors having the relatively smallest hamming distance are not equivalent to a predetermined schedule; and in response to a determination that the determined difference of the third mean and the fourth mean is less than the predetermined value, determining that the service placements associated with the bit vectors having the relatively smallest hamming distance are equivalent, and outputting an indication that the service placements associated with the bit vectors having the relatively smallest hamming distance are equivalent to the predetermined schedule.

6. The computer-implemented method of claim 5, wherein each of the bit vectors include groups of bits that represent different associated services of the service placements, wherein each group of bits includes sub-groups of bits, wherein each sub-group of bits represent an edge site, wherein the bits of each sub-group of bits represent servers of the edge site, wherein values of the bits of each sub-group of bits indicate whether the associated service is deployed on servers of the edge site.

7. The computer-implemented method of claim 1, wherein the metrics of the first log information and the metrics of the second log information are the same type of metrics, wherein the metrics are selected from the group consisting of: central processing unit (CPU) utilization, load, average power consumption, peak power consumption, throughput, response time, and tail latency.

8. The computer-implemented method of claim 1, wherein the metrics of the first log information and the metrics of the second log information are the same type of metrics, wherein a first of the metrics is a number of page faults.

9. The computer-implemented method of claim 1, wherein the predetermined value is epsilon.

10. A computer program product, the computer program product comprising a computer readable storage medium having program instructions embodied therewith, the program instructions readable and/or executable by a computer to cause the computer to:
obtain log information;
in response to a determination that the log information includes first log information associated with a first configuration of a first edge site and second log information associated with a second configuration of a second edge site, perform a first predetermined equivalence test, wherein the first predetermined equivalence test includes:
generating first configuration probability distributions based on metrics of the first log information;
generating second configuration probability distributions based on metrics of the second log information;
calculating a first mean of the first configuration probability distributions and a second mean of the second configuration probability distributions;
determining a difference of the first mean and the second mean; and
in response to a determination that the determined difference of the first mean and the second mean is greater than a predetermined value, causing the second configuration of the second edge site to be used for a service request.

11. The computer program product of claim 10, the program instructions readable and/or executable by the computer to cause the computer to: in response to a determination that the determined difference is less than the predetermined value, cause the first configuration of the first edge site to be used for the service request.

12. The computer program product of claim 10, wherein causing the second configuration of the second edge site to be used for the service request includes instructing a predetermined schedule to schedule the service request to be fulfilled by a server included in the second configuration, wherein causing the first configuration of the first edge site to be used for the service request includes instructing the schedule to schedule the service request to be fulfilled by a server associated with the first configuration.

13. The computer program product of claim 10, the program instructions readable and/or executable by the computer to cause the computer to:
in response to a determination that the log information does not include the first log information and/or the second log information, perform a second predetermined equivalence test, wherein the second predetermined equivalence test includes:
identifying third log information associated with a plurality of service placements;
using the third log information to generate bit vectors for each of the service placements;
calculating hamming distances for pairings of the bit vectors;
identifying a pairing of the bit vectors having a relatively smallest hamming distance;
calculating a third mean based on metrics associated with a first of the bit vectors having the relatively smallest hamming distance;
calculating a fourth mean based on metrics associated with a second of the bit vectors having the relatively smallest hamming distance;
determining whether a difference of the third mean and the fourth mean is greater than the predetermined value; and
in response to a determination that the determined difference of the third mean and the fourth mean is greater than the predetermined value, determining that the service placements associated with the bit vectors having the relatively smallest hamming distance are not equivalent.

14. The computer program product of claim 13, the program instructions readable and/or executable by the computer to cause the computer to: output an indication that the service placements associated with the bit vectors having the relatively smallest hamming distance are not equivalent to a predetermined schedule; and in response to a determination that the determined difference of the third mean and the fourth mean is less than the predetermined value, determine that the service placements associated with the bit vectors having the relatively smallest hamming distance are equivalent, and outputting an indication that the service placements associated with the bit vectors having the relatively smallest hamming distance are equivalent to the predetermined schedule.

15. The computer program product of claim 14, wherein each of the bit vectors include groups of bits that represent different associated services of the service placements, wherein each group of bits includes sub-groups of bits, wherein each sub-group of bits represent an edge site, wherein the bits of each sub-group of bits represent servers of the edge site, wherein values of the bits of each sub-group of bits indicate whether the associated service is deployed on servers of the edge site.

16. The computer program product of claim 10, wherein the metrics of the first log information and the metrics of the second log information are the same type of metrics, wherein the metrics are selected from the group consisting of: central processing unit (CPU) utilization, load, average power consumption, peak power consumption, throughput, response time, and tail latency.

17. The computer program product of claim 10, wherein the metrics of the first log information and the metrics of the second log information are the same type of metrics, wherein a first of the metrics is a number of page faults.

18. The computer program product of claim 10, wherein the predetermined value is epsilon.

19. A system, comprising:
a processor; and
logic integrated with the processor, executable by the processor, or integrated with and executable by the processor, the logic being configured to:
obtain log information;
in response to a determination that the log information includes first log information associated with a first configuration of a first edge site and second log information associated with a second configuration of a second edge site, perform a first predetermined equivalence test, wherein the first predetermined equivalence test includes:
generating first configuration probability distributions based on metrics of the first log information;
generating second configuration probability distributions based on metrics of the second log information;
calculating a first mean of the first configuration probability distributions and a second mean of the second configuration probability distributions;
determining a difference of the first mean and the second mean; and
in response to a determination that the determined difference of the first mean and the second mean is greater than a predetermined value, causing the second configuration of the second edge site to be used for a service request.

20. The system of claim 19, the logic being configured to: in response to a determination that the determined difference is less than the predetermined value, cause the first configuration of the first edge site to be used for the service request.
